(19) United States
(12) Patent Application Publication
(10) Pub. No.: US 2016/0138697 A1
(43) Pub. Date: May 19, 2016

(54) GEAR ASSEMBLY

(71) Applicant: Caterpillar Inc., Peoria, IL (US)

(72) Inventors: Gopi K. C. Kancherla, Peoria, IL (US); Gary W. Copeland, Peoria, IL (US)

(73) Assignee: Caterpillar Inc., Peoria, IL (US)

(21) Appl. No.: 14/547,239

(22) Filed: Nov. 19, 2014

(51) Int. Cl. F16H 55/18; F16H 57/00

(52) U.S. Cl. CPC F16H 55/18; F16H 57/0006

(57) ABSTRACT

A gear assembly is provided. The gear assembly includes a first gear. The first gear defines at least one slot provided on a surface thereof. The gear assembly also includes a second gear. The second gear includes at least one tab extending axially from a surface of the second gear. The at least one tab is configured to engage at least partially within the at least one slot of the first gear. The gear assembly further includes a resilient material provided within the at least one slot and in contact with the at least one tab of the second gear. The resilient material is configured to provide a restoring force to bias the at least one tab toward an end of the at least one slot for controlling backlash during meshing of the gear assembly.

### TECHNICAL FIELD

The present disclosure relates to a gear assembly, and more specifically to a gear assembly associated with a gear train of an engine system.

### BACKGROUND

A transmission system associated with an engine or a machine includes one or more gear trains for transmission of power from one component to another. The gear trains in such systems employ one or more gears, which mesh with one another during rotation thereof. Sometimes, due to various reasons, such as, manufacturing tolerance, surface wear during operation of the gears, or prolonged operation, a backlash may develop between corresponding teeth of the meshed gears. In some situations, the backlash may be intentionally provided during manufacturing, for ease of assembly or prevention of seizure during operation due to material expansion. However, this backlash may result in increased noise during operation of the gear train, increased wear of the meshed gears, increased service interval and, thereby cause an increase in overall maintenance and operational costs.

U.S. Pat. No. 6,997,076 describes a gear transmission for minimizing backlash. The gear transmission includes a first shaft and a first roller slidably positioned on the first shaft. The gear transmission includes a first gear positioned on the first shaft. The gear transmission also includes a second shaft and a second roller positioned on the second shaft and adjacent the first roller. The gear transmission further includes a second gear positioned on the second shaft and adjacent the first gear. The first roller and the second roller abut when teeth of the first gear mesh with teeth of the second gear.

### SUMMARY OF THE DISCLOSURE

In one aspect of the present disclosure, a gear assembly is provided. The gear assembly includes a first gear configured to rotate about an axis. The first gear defines at least one slot provided on a surface thereof. The gear assembly also includes a second gear provided coaxially with respect to the first gear. The second gear is provided to mate with the first gear. The second gear includes at least one tab extending axially from a surface of the second gear. The at least one tab is configured to engage at least partially within the at least one slot of the first gear. The at least one tab is sized smaller than a size of the at least one slot. The gear assembly further includes a resilient material provided within the at least one slot and in contact with the at least one tab of the second gear. The resilient material is configured to provide a restoring force to bias the at least one tab toward an end of the at least one slot for controlling backlash during meshing of the gear assembly.

In another aspect of the present disclosure, a gear train is provided. The gear train includes a driving gear and a gear assembly provided in mesh with the driving gear. The gear assembly includes a first gear configured to rotate about an axis. The first gear defines at least one slot provided on a surface thereof. The gear assembly also includes a second gear provided coaxially with respect to the first gear. The second gear is provided to mate with the first gear. The second gear includes at least one tab extending axially from a surface of the second gear. The at least one tab is configured to engage at least partially within the at least one slot of the first gear. The at least one tab is sized smaller than a size of the at least one slot. The gear assembly further includes a resilient material provided within the at least one slot and in contact with the at least one tab of the second gear. The resilient material is configured to provide a restoring force to bias the at least one tab toward an end of the at least one slot for controlling backlash during meshing of the gear assembly.

In yet another aspect of the present disclosure, an engine system is provided. The engine system includes an engine and a gear train associated with the engine. The gear train includes a driving gear and a gear assembly provided in mesh with the driving gear. The gear assembly includes a first gear configured to rotate about an axis. The first gear defines at least one slot provided thereon. The gear assembly also includes a second gear provided coaxially with respect to the first gear. The second gear is provided to mate with the first gear. The second gear includes at least one tab extending axially from a surface of the second gear. The at least one tab is configured to engage at least partially within the at least one slot of the first gear. The at least one tab is sized smaller than a size of the at least one slot. The gear assembly further includes a resilient material provided within the at least one slot and in contact with the at least one tab of the second gear. The resilient material is configured to provide a restoring force to bias the at least one tab toward an end of the at least one slot for controlling backlash during meshing of the gear assembly with the driving gear.

Other features and aspects of this disclosure will be apparent from the following description and the accompanying drawings.

### BRIEF DESCRIPTION OF THE DRAWINGS

FIG. 1 is a perspective view of an exemplary gear train, according to an embodiment of the present disclosure;

FIG. 2 is an enlarged view of an exemplary gear assembly of the gear train of FIG. 1 provided in mesh with a driving gear and a driven gear, according to an embodiment of the present disclosure;

FIG. 3 is an exploded view of the gear assembly, according to an embodiment of the present disclosure; and

FIG. 4 is a cross sectional view of the gear assembly, according to an embodiment of the present disclosure.

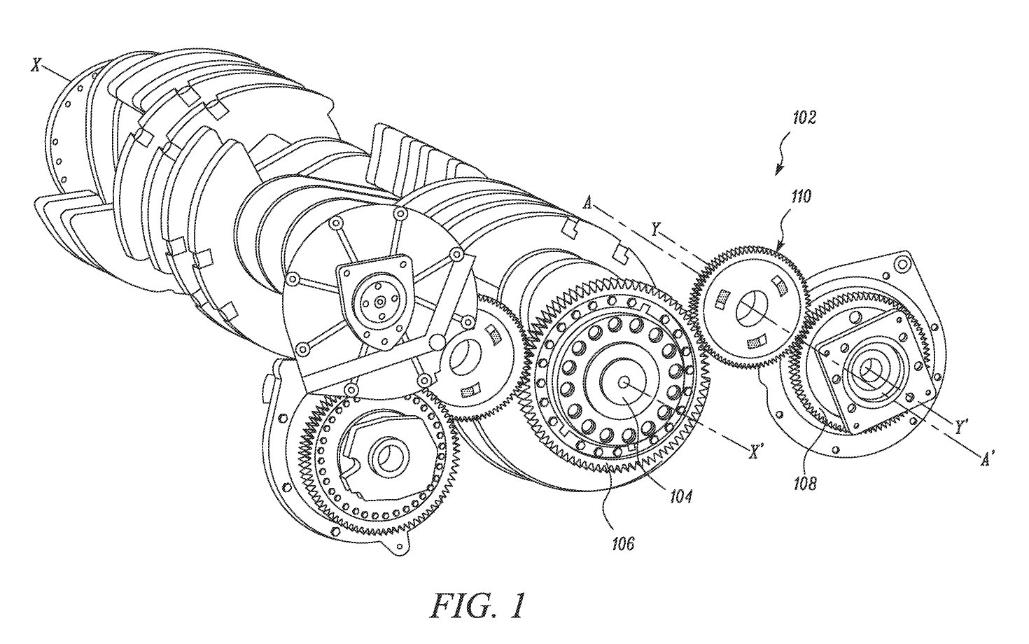

### DETAILED DESCRIPTION

Wherever possible, the same reference numbers will be used throughout the drawings to refer to the same or similar parts. Referring to FIG. 1, a perspective view of an exemplary gear train 102 is illustrated. The gear train 102 may be associated with an engine system (not shown). In other embodiments, the gear train 102 may be associated with any other machine (not shown) known to one skilled in the art. The engine system may include an engine (not shown). The engine may be any power source known in the art powered by a fuel, such as, gasoline, diesel, natural gas, and so on or a combination thereof. The engine system may include a crankshaft 104 associated with the engine. Additionally, the engine system includes the gear train 102 operatively coupled to the crankshaft 104. The crankshaft 104 and the gear train 102 are configured to transfer motive power generated by the engine to other components of the engine system.

The gear train 102 includes a crank gear, hereinafter referred to as a driving gear 106 coupled to the crankshaft 104. The gear train 102 also includes an accessory gear, hereinafter referred to as a driven gear 108. The driven gear 108 may be associated with any accessory or component of the engine system, such as, a coolant pump, a fuel pump, an engine valve assembly, and so on. The gear train 102 further includes an idler gear, hereinafter referred to as a gear assembly 110. The gear assembly 110 is provided in mesh with the driving gear 106 and the driven gear 108. The gear assembly 110 is configured to transfer motive power from the driving gear 106 to the driven gear 108. In some embodiments, the gear assembly 110 may be configured to vary a torque and/or a speed between the driving gear 106 and the driven gear 108 using a suitable gear ratio therebetween. It should be noted that, in some embodiments, the gear assembly 110 may include the driving gear 106, the driven gear 108 or both.

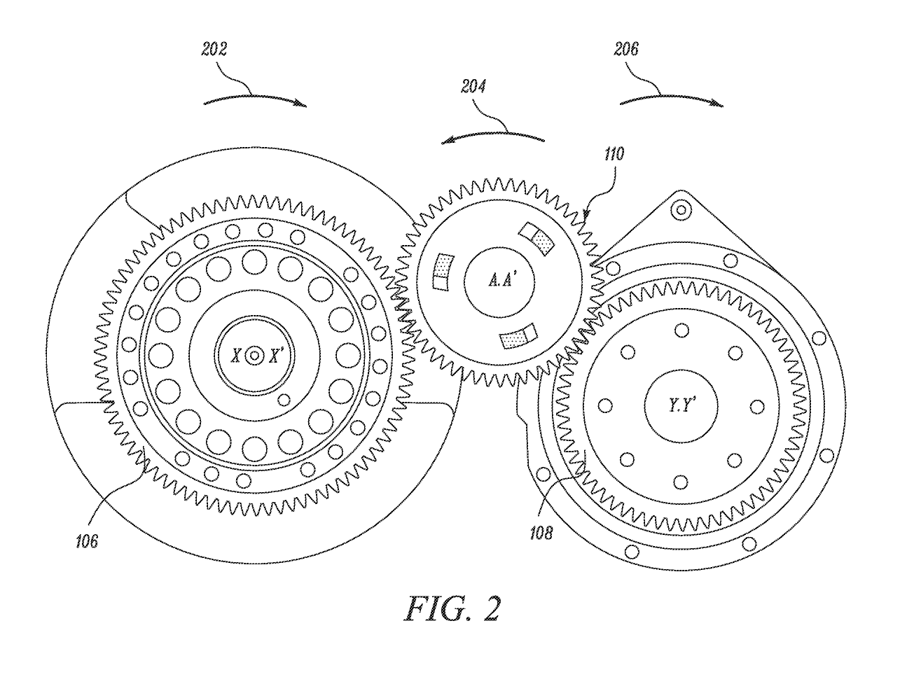

FIG. 2 shows the driving gear 106, the driven gear 108, and the gear assembly 110 in mesh with one another. The driving gear 106 rotates in a clockwise direction about an axis X-X′ as shown by an arrow 202. The gear assembly 110 rotates in an anticlockwise direction about an axis A-A′ as shown by an arrow 204. Further, the driven gear 108 rotates in the clockwise direction about an axis Y-Y′, as shown by an arrow 206. It should be noted that the direction of rotation of the driving gear 106, the gear assembly 110, and the driven gear 108 described herein is merely exemplary and does not limit the scope of this disclosure. In other embodiments, the driving gear 106, the gear assembly 110, and the driven gear 108 may rotate in a suitable direction based on system design and requirements. Further, in yet other embodiments the gear train 102 may additionally or optionally include multiple driven gears 108 provided in mesh with the gear assembly 110.

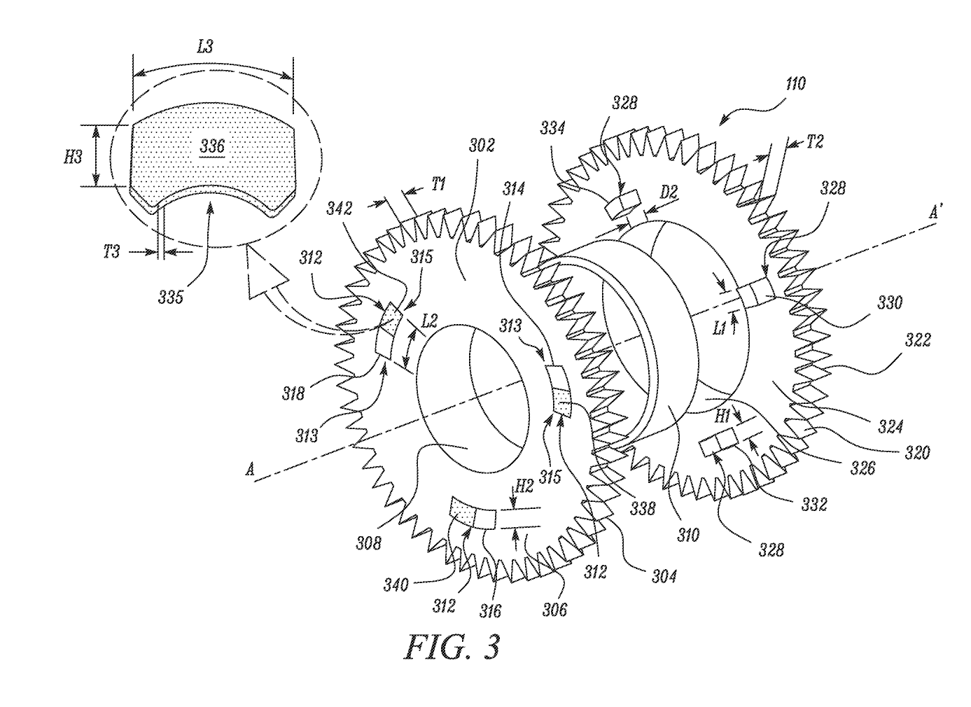

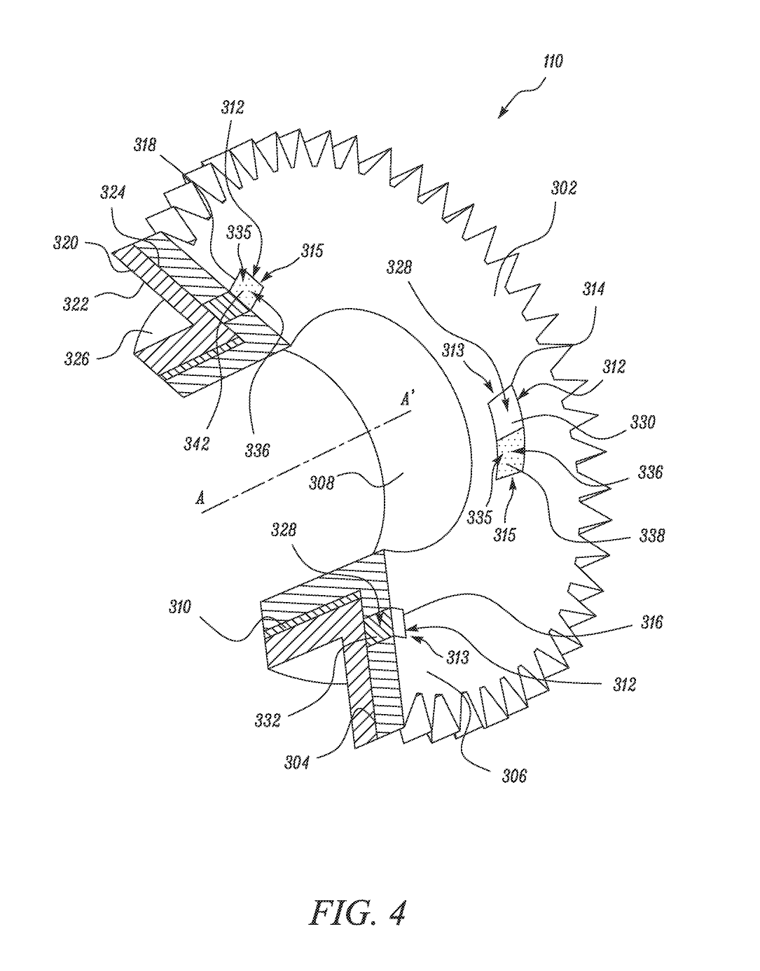

Referring to FIG. 3, an exploded view of the gear assembly 110 is illustrated. FIG. 4 is a cross sectional view of the gear assembly 110 when assembled. The gear assembly 110 includes a first gear 302 configured to rotate about the axis A-A′. The first gear 302 includes a first surface 304 and a second surface 306 and defining a thickness “T1” therebetween. The first gear 302 includes a hub 308 provided on the first surface 304 and extending axially therefrom. The hub 308 has a hollow and cylindrical configuration. The hub 308 is configured to receive a bushing 310 thereon. In other embodiments, the hub 308 may be configured to receive a bearing assembly (not shown). The hub 308 is also configured to fixedly mount the first gear 302 on a shaft (not shown) of the engine assembly.

Also, the first gear 302 includes at least one slot 312 provided on the first surface 304 thereof. The slot 312 is shaped such that a depth “D1” of the slot 312 may be equal to the thickness “T1” of the first gear 302, thereby causing the slot 312 to form a through hole on the first gear 302. In some embodiments, the slot 312 may be provided as a depression on the first surface 304 such that the depth “D1” of the slot 312 may be lesser than the thickness “T1” of the first gear 302. Further, the slot 312 has an arcuate shape defining a first end 313 and a second end 315. In other embodiments, the slot 312 may have any other shape, such as, triangular, oval, circular, or polygonal. The shape of the slot 312 may be symmetrical or asymmetrical, based on the requirements of the systems. In the illustrated embodiment, the slot 312 on the first gear 302 is embodied as a first slot 314, a second slot 316 and a third slot 318. Also, the first, second and third slots 314, 316, 318 are equally spaced from one another on the first gear 302. A person of ordinary skill in the art will appreciate that the number of the slots 312 provided on the first gear 302 and the shape and position of the slots 312 may vary.

The gear assembly 110 includes a second gear 320 provided coaxially with respect to the first gear 302 and configured to rotate about the axis A-A′. When assembled, the second gear 320 is provided adjacent to the first gear 302 and configured to mate therewith. The second gear 320 includes a first surface 322 and a second surface 324 defining a thickness “T2” therebetween. The second gear 320 includes a hub 326 provided on the first surface 322 and extending axially therefrom. The hub 326 has a hollow, cylindrical configuration. The hub 326 is configured to rotatably mount the second gear 320 either on the hub 308 of the first gear 302 or on the bushing 310. The bushing 310 is configured to provide a bearing surface between the first and second gears 302, 320.

Also, the second gear 320 includes at least one tab 328 extending axially from the second surface 324. The tab 328 on the second gear 320 is provided in cooperation with the slot 312 of the first gear 302. A shape of the tab 328 at least partially corresponds to the shape of the slot 312. In the illustrated embodiment, the shape of the tab 328 is partially arcuate to correspond to the arcuate shape of the slot 312. In other embodiments, the tab 328 may have any other shape, such as, triangular, oval, circular, or polygonal corresponding to the shape of the slot 312. The tab 328 is sized smaller than a size of the slot 312, allowing for the tab 328 to be easily received into or engaged within the slot 312. For example, a height “H1” of the tab 328 may be approximately equal to or smaller than a height “H2” of the slot 312, and a length “L1” of the tab 328 may be substantially lesser than a length “L2” of the slot 312. Also, a depth “D2” of the tab 328 may be approximately equal or lesser than the depth “D1” of the slot 312. In another example, the height “H1” and the depth “D2” of the tab 328 may be lesser than the height “H2” and the depth “D1” of the slot 312 respectively. In yet another example, the length “L1” and the depth “D2” of the tab 328 may be lesser than the length “L2” and the depth “D1” of the slot 312 respectively.

In the illustrated embodiment, the tab 328 on the second gear 320 is embodied as a first tab 330, a second tab 332 and a third tab 334. The first, second and third tabs 330, 332, 334 are provided in cooperation with the first, second and third slots 314, 316, 318 respectively. The first, second and third tabs 330, 332, 334 are equally spaced from one another on the second gear 320. When assembled, the first, second and third tabs 330, 332, 334 are configured to engage at least partially within the first, second and third slots 314, 316, 318 respectively.

A resilient material 335 is provided in the slot 312. More specifically, the resilient material 335 is a wire mesh 336. In other embodiments, the resilient material 335 may be a spring, a U-shaped pin, and so on. The wire mesh 336 is also provided in contact with the tab 328 of the second gear 320 within the slot 312. A shape of the wire mesh 336 at least partially corresponds to the shape of the slot 312. In the illustrated embodiment, the shape of the wire mesh 336 is partially arcuate to correspond to the arcuate shape of the slot 312. In other embodiments, the wire mesh 336 may have any other shape, such as, triangular, oval, circular, or polygonal, corresponding to the shape of the slot 312.

The wire mesh 336 is sized smaller than the size of the slot 312 so that the wire mesh 336 and the tab 328 may together be accommodated within the slot 312. In one example, a height “H3” of the wire mesh 336 may be approximately equal or lesser than the height “H2” of the slot 312. In another example, a length “L3” of the wire mesh 336 is approximately equal or greater than half of the length “L2” of the slot 312, such that a portion of the slot 312 that is unoccupied by the tab 328 may be used to accommodate the wire mesh 336 therein. In yet another example, a thickness “T3” of the wire mesh 336 may be approximately equal, lesser or greater than the depth “D1” of the slot 312. In the accompanying figures, the wire mesh 336 of the gear assembly 110 is embodied as a first wire mesh 338, a second wire mesh 340 and a third wire mesh 342 provided within the first slot 314, the second slot 316 and the third slot 318 respectively.

The wire mesh 336 is coupled within the slot 312 by any known fastening method, such as, welding, riveting, bolting, and adhesion. The wire mesh 336 may be made of any metal or alloy known in the art. The wire mesh 336 is configured to provide a restoring force to bias the tab 328 toward a first end 313 of the slot 312 for controlling backlash during the meshing of the gear assembly 110 with the driving gear 106, the driven gear 108 or both. In some embodiment, the wire mesh 336 is configured to reduce the backlash of the meshed driving gear 106 and the gear assembly 110, due to the restoring force generated by the wire mesh 336. In some other embodiments, the wire mesh 336 is configured to minimize or eliminate the backlash of the meshed driving gear 106 and the gear assembly 110 based on the restoring force provided by the wire mesh 336.

One of ordinary skill in the art will appreciate that the restoring force is generated due to material properties of the wire mesh 336. Moreover, the restoring force generated by the wire mesh 336 is based on at least one parameter of the wire mesh 336. The parameter of the wire mesh 336 may include a density, a volume, and the thickness “T3” of the wire mesh 336. The working of the wire mesh 336 to control the backlash will be explained in the next section. It should be noted that location, number, dimension and shape of the slot 312, the tab 328 and/or the wire mesh 336 described herein is merely exemplary and may vary as per system design and requirements without limiting scope of this disclosure. Additionally, in some embodiments, the location of the slot 312 provided on the first gear 302 and the tab 328 provided on the second gear 320 may be interchanged such as the slot 312 may be provided on the second gear 320 and the tab 328 may be provided on the first gear 302.

### INDUSTRIAL APPLICABILITY

During assembly, the bushing 310 is fixedly mounted over the hub 308 of the first gear 302 of the gear assembly 110. The hub 308 of the second gear 320 is then slid over the bushing 310 in a manner such that the second gear 320 is rotatably mounted on the bushing 310 or the hub 308 of the first gear 302. Additionally, each of the first, second and third tabs 330, 332, 334 is engaged within each of the first, second and third slots 314, 316, 318 respectively. Further, each of the first, second and third wire meshes 338, 340, 342 is provided within each of the first, second and third slots 314, 316, 318 respectively, and in contact with each of the first, second and third tabs 330, 332, 334 respectively.

The working of the wire mesh 336 for controlling the backlash between the driving gear 106, the gear assembly 110, or the driven gear 108 during meshing will now be explained. For the purpose of explanation, the method will now be explained with reference to the driving gear 106. It should be noted that the method may be employed in a similar manner for controlling the backlash between the gear assembly 110 and the driven gear 108.

During operation of the gear train 102, the gear assembly 110 rotates about the axis A-A′ in the clockwise direction as shown by the arrow 204. During operation, teeth of both the first and second gears 302, 320 of the gear assembly 110 mesh simultaneously with corresponding teeth of the driving gear 106. Additionally, during operation, each of the first, second and third tabs 330, 332, 334 may press against and compress each of the first, second and third wire meshes 338, 340, 342 respectively.

During stationary state of the gear train 102, the gear assembly 110 is stationary with respect to the driving gear 106. In such a situation, each of the first, second and third wire meshes 338, 340, 342 expand within each of the first, second and third slots 314, 316, 318 respectively to their original shape. The expansion of each of the first, second and third wire meshes 338, 340, 342 provide the restoring force against each of the first, second and third tabs 330, 332, 334 respectively. The restoring force may provide meshing of the teeth of the first and second gears 302, 320 with the teeth of the driving gear 106 for controlling the backlash therebetween. In one embodiment, the parameters of each of the first, second and third wire meshes 338, 340, 342 may be so chosen as to reduce the backlash between the driving gear 106 and the gear assembly 110. In another embodiment, the parameters of each of the first, second and third wire meshes 338, 340, 342 may be selected to minimize or eliminate the backlash between the driving gear 106 and the gear assembly 110.

The number of the wire meshes 336, the density and the volume of each of the wire meshes 336 may be tuned based on the torque transferred by the gear train 102. The addition to controlling the backlash, the wire mesh 336 may provide damping between the first and second gears 302, 320, absorb vibrations and accommodate thermal expansion between the meshing driving gear 108 and the gear assembly 110. Further, the wire mesh 336 may provide a cost effective solution of controlling the backlash as the wire mesh 336 may be relatively inexpensive to manufacture. Also, the wire mesh 336 may be relative easy to assemble during manufacture of the gear assembly 110 and may have a relatively small footprint.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A gear assembly comprising:
a first gear configured to rotate about an axis, the first gear defining at least one slot provided on a surface thereof;
a second gear provided coaxially with respect to the first gear, the second gear provided to mate with the first gear, the second gear including at least one tab extending axially from a surface of the second gear, the at least one tab configured to engage at least partially within the at least one slot of the first gear, wherein the at least one tab is sized smaller than a size of the at least one slot; and
a resilient material provided within the at least one slot and in contact with the at least one tab of the second gear, the resilient material configured to provide a restoring force to bias the at least one tab toward an end of the at least one slot for controlling backlash during meshing of the gear assembly.

2. The gear assembly of claim 1, wherein the resilient material is a wire mesh.

3. The gear assembly of claim 1, wherein the at least one slot has an arcuate shape.

4. The gear assembly of claim 3, wherein a shape of the resilient material is at least partially arcuate to correspond with the shape of the at least one slot.

5. The gear assembly of claim 1, wherein a length of the resilient material is greater than at least half of a length of the at least one slot.

6. The gear assembly of claim 1, wherein the restoring force provided by the resilient material is based on at least one of a density, a volume, and a thickness of the resilient material.

7. The gear assembly of claim 1, wherein the at least one slot provided on the first gear further includes a first slot, a second slot, and a third slot, and wherein the at least one tab on the second gear further includes a first tab, a second tab, and a third tab, such that the first tab, the second tab and the third tab engage with the first slot, the second slot, and the third slot respectively, and wherein the resilient material includes a first resilient material, a second resilient material, and a third resilient material to contact with the first tab, the second tab and the third tab respectively.

8. The gear assembly of claim 1, wherein:
the first gear is rigidly affixed to a shaft; and
the second gear is rotatably mounted on a hub of the first gear.

9. The gear assembly of claim 1 further comprising a bushing provided between the first gear and the second gear.

10. A gear train comprising:
a driving gear; and
a gear assembly provided in mesh with the driving gear, the gear assembly comprising:
a first gear configured to rotate about an axis, the first gear defining at least one slot provided on a surface thereof;
a second gear provided coaxially with respect to the first gear, the second gear provided to mate with the first gear, the second gear including at least one tab extending axially from a surface of the second gear, the at least one tab configured to engage at least partially within the at least one slot of the first gear, wherein the at least one tab is sized smaller than a size of the at least one slot; and
a resilient material provided within the at least one slot and in contact with the at least one tab of the second gear, the resilient material configured to provide a restoring force to bias the at least one tab toward an end of the at least one slot for controlling backlash during meshing of the gear assembly with the driving gear.

11. The gear train of claim 10, wherein the resilient material is a wire mesh.

12. The gear train of claim 10, wherein the at least one slot has an arcuate shape.

13. The gear train of claim 12, wherein a shape of the resilient material is at least partially arcuate to correspond with the shape of the at least one slot.

14. The gear train of claim 10, wherein a length of the resilient material is greater than at least half of a length of the at least one slot.

15. The gear train of claim 10, wherein the restoring force provided by the resilient material is based on at least one of a density, a volume, and a thickness of the resilient material.

16. The gear train of claim 10, wherein the at least one slot provided on the first gear further includes a first slot, a second slot, and a third slot, and wherein the at least one tab on the second gear further includes a first tab, a second tab, and a third tab, such that the first tab, the second tab and the third tab engage with the first slot, the second slot, and the third slot respectively, and wherein the resilient material includes a first resilient material, a second resilient material, and a third resilient material to contact with the first tab, the second tab and the third tab respectively.

17. The gear train of claim 10 further comprising a shaft such that the first gear is rigidly affixed to the shaft, and wherein the second gear is rotatably mounted on a hub of the first gear.

18. The gear train of claim 10 further comprising a bushing provided between the first gear and the second gear.

19. An engine system comprising:
an engine; and
a gear train associated with the engine, the gear train comprising:
a driving gear; and
a gear assembly provided in mesh with the driving gear, the gear assembly comprising:
a first gear configured to rotate about an axis, the first gear defining at least one slot provided on a surface thereof;
a second gear provided coaxially with respect to the first gear, the second gear provided to mate with the first gear, the second gear including at least one tab extending axially from a surface of the second gear, the at least one tab configured to engage at least partially within the at least one slot of the first gear, wherein the at least one tab is sized smaller than a size of the at least one slot; and
a resilient material provided within the at least one slot and in contact with the at least one tab of the second gear, the resilient material configured to provide a restoring force to bias the at least one tab toward an end of the at least one slot for controlling backlash during meshing of the gear assembly with the driving gear.

20. The engine system of claim 19, wherein the at least one slot provided on the first gear further includes a first slot, a second slot, and a third slot, and wherein the at least one tab on the second gear further includes a first tab, a second tab, and a third tab, such that the first tab, the second tab and the third tab engage with the first slot, the second slot, and the third slot respectively, and wherein the resilient material includes a first resilient material, a second resilient material, and a third resilient material to contact with the first tab, the second tab and the third tab respectively.
